(19) United States
(12) Patent Application Publication
(10) Pub. No.: US 2008/0214240 A1
(43) Pub. Date: Sep. 4, 2008

(54) METHOD AND APPARATUS FOR CONNECTING EMERGENCY CALL IN PORTABLE TERMINAL

(75) Inventors: Jong-Mu CHOI, Gunpo-si (KR); Hee-Jung Chae, Suwon-si (KR); Jung-Hun Lee, Suwon-si (KR); Mi-Soon Kim, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/972,728

(22) Filed: Jan. 11, 2008

(30) Foreign Application Priority Data
Jan. 12, 2007 (KR) 2007-0003792

(51) Int. Cl. H04B 1/38; H04M 11/04; H04L 12/66

(52) U.S. Cl. 455/558; 455/404.1; 370/352; 455/552.1

(57) ABSTRACT

A method and apparatus for connection an emergency call in a dual mode portable terminal supporting both a cellular network and an unlicensed-band network using an unlicensed Industrial, Science, and Medical (ISM) frequency band (e.g., WiFi, Bluetooth, UWB, etc.) are provided. The method includes if an emergency call connection event occurs, searching for an accessible network and checking an insertion state of a SIM card; if the unlicensed-band network is accessible and the SIM card is not inserted, performing an IP-based Multimedia Subsystem (IMS) registration process by using information pre-stored in a memory; and connecting the emergency call through the unlicensed-band network.

### PRIORITY

This application claims priority under 35 U.S.C. § 119(a) to a Korean Patent Application filed in the Korean Intellectual Property Office on Jan. 12, 2007 and assigned Serial No. 2007-3792, the contents of which are incorporated herein by reference.

### BACKGROUND OF THE INVENTION

1. Field of the Invention

The present invention relates to a method and apparatus for connecting an emergency call in a portable terminal, and in particular, to a method and apparatus for connecting an emergency call in an unlicensed-band by using an IP-based Multimedia Subsystem (IMS) network in a state where a Subscriber Identification Module (SIM) card is not inserted in a dual mode portable terminal supporting a cellular network and an unlicensed-band network.

2. Description of the Related Art

Today, mobile service providers are conducting extensive research and development in portable terminal emergency call techniques that enable emergency calls to be placed by a user in situations where the user encounters an emergency.

In this case, since portable terminals have been developed to support an access protocol that uses both a cellular band and an unlicensed wireless frequency band, a dual mode portable terminal can now perform a handover process between a cellular network and an unlicensed network in both voice and data sessions, and thus communication can be achieved when the portable terminal moves between the cellular network and the unlicensed frequency network. For example, a portable terminal supporting both a Global System for Mobile communication (GSM) network and a WiFi network, or a portable terminal supporting both a Universal Mobile Telecommunications System (UMTS) network and the WiFi network are currently being marketed.

FIG. 1 is a flowchart illustrating a conventional process of connecting an emergency call in a portable terminal. The portable terminal supports an IP-based Multimedia Subsystem (IMS) Voice over Internet Protocol (VoIP) through a WiFi network, which is the aforementioned unlicensed-band network, and also supports the cellular voice communication.

In FIG. 1, in step 101, it is checked whether a Subscriber Identification Module (SIM) card is properly inserted into the dual mode portable terminal supporting both the cellular network and the WiFi network. Upon detecting the insertion of the SIM card, in step 103, a currently accessible network is searched. Thereafter, in step 105, the accessibility to the WiFi network is determined.

If the WiFi network is accessible, in step 107, an IMS core network registration process is performed using IMS related information recorded in the SIM card. In step 109, an emergency call is connected using an IMS VoIP through the WiFi network. The process is then ended.

However, if the WiFi network is not accessible, in step 111, connection to the cellular network is attempted using the cellular network, and the process is then ended.

In step 101, if the insertion of the SIM card is not detected, in step 113, a currently accessible network is searched. In step 115, it is determined whether the cellular network is not accessible and only the WiFi network is accessible.

If the cellular network is accessible, in step 117, the emergency call connection is attempted using the cellular network. If the only accessible network is the WiFi network, in step 119, it is determined that the emergency call cannot be connected. The process is then ended.

As described above, in order for a VoIP call to be connected through the unlicensed-band network, the portable terminal, which supports the cellular network and the WiFi network (i.e., the unlicensed-band network), is registered to the IMS core network by reading IMS related information from the SIM card.

Accordingly, a conventional portable terminal typically has a problem in that the emergency call cannot be connected when the SIM card is not inserted in the portable terminal and when the SIM card is set in a state where emergency calls are only accessible through the unlicensed-band network.

### SUMMARY OF THE INVENTION

An aspect of the present invention is to substantially solve at least the above problems and/or disadvantages and to provide at least the advantages below. Accordingly, one aspect of the present invention is to provide a method and apparatus for connecting an emergency call in a portable terminal.

Another aspect of the present invention is also to provide a method and apparatus for connecting an emergency call when a Subscriber Identification Module (SIM) card is not inserted into a dual mode portable terminal supporting a cellular network and an unlicensed-band network.

According to one aspect of the present invention, there is provided a method of connecting an emergency call in a portable terminal supporting a cellular network and an unlicensed-band network. The method includes if an emergency call connection event occurs, searching for an accessible network and checking an insertion state of a SIM card; if the unlicensed-band network is accessible and the SIM card is not inserted, performing an IP-based Multimedia Subsystem (IMS) registration process by using information pre-stored in a memory; and connecting the emergency call through the unlicensed-band network.

According to another aspect of the present invention, there is provided an apparatus for connecting an emergency call in a portable terminal supporting a cellular network and an unlicensed-band network. The apparatus includes a memory for storing information which is recorded in a SIM card and is used when an IMS registration process is last performed; a controller for reading the information stored in the memory and outputting the read information to a communication module when an emergency call event occurs in a state that the unlicensed-band network is accessible; and the communication module for performing the IMS registration process by using the information stored in the memory and connecting an emergency call through the unlicensed-band network.

### BRIEF DESCRIPTION OF THE DRAWINGS

The above and other objects, features and advantages of the present invention will become more apparent from the following detailed description when taken in conjunction with the accompanying drawings in which:

FIG. 1 is a flowchart illustrating a conventional process of connecting an emergency call in a portable terminal;

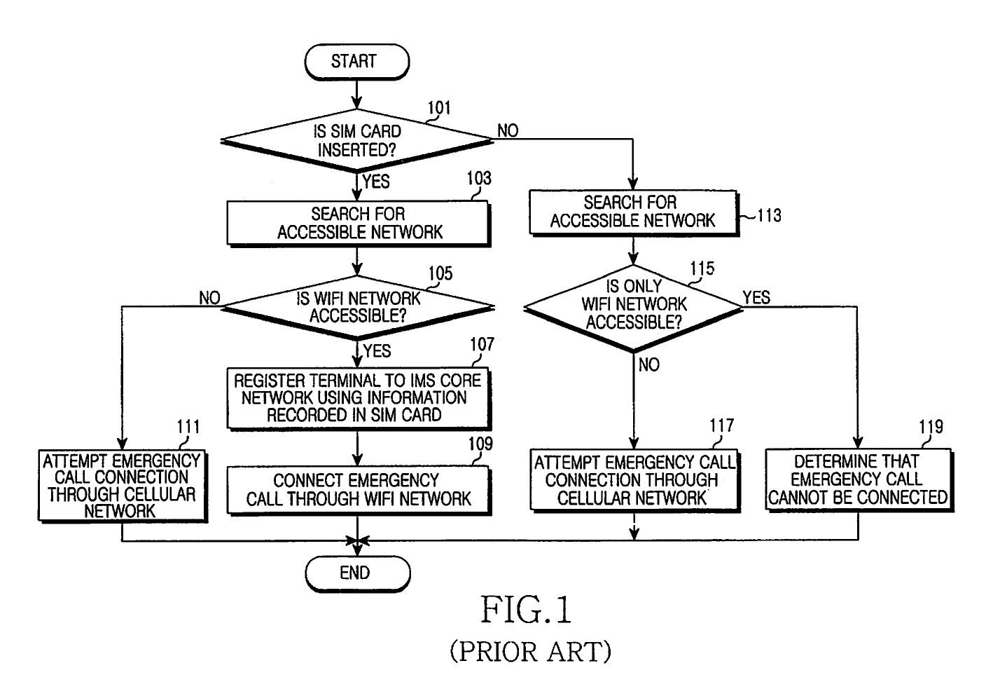

FIG. 2 is a block diagram of a portable terminal according to the present invention; and

FIG. 3 is a flowchart illustrating a process of connecting an emergency call in a portable terminal according to the present invention.

### DETAILED DESCRIPTION OF THE PREFERRED EMBODIMENTS

A preferred embodiment of the present invention will be described herein below with reference to the accompanying drawings. In the following description, well-known functions or constructions are not described in detail since they would obscure the invention in unnecessary detail.

A method and apparatus for connecting an emergency call using information recorded in a Subscriber Identification Module (SIM) card will is described below wherein the information is also pre-stored in a memory of a dual mode portable terminal supporting a cellular network (e.g., GSM or UMTS) and an unlicensed-band network. Furthermore, the SIM card is an IMS Subscriber Identification Module (ISIM) card that has the information required in an IMS network registration process. The unlicensed-band network uses an unlicensed Industrial, Science, and Medical (ISM) wireless frequency band. Examples of the unlicensed-band include WiFi (IEEE 802.11, HyperLan), Bluetooth, 802.15.4, and Ultra Wide Band (UVB). The present invention applies to all unlicensed-band networks, and the WiFi network is described hereinafter for example. In addition, the following descriptions are explained under the assumption that the dual mode portable terminal can access to the cellular network and/or the unlicensed-band network.

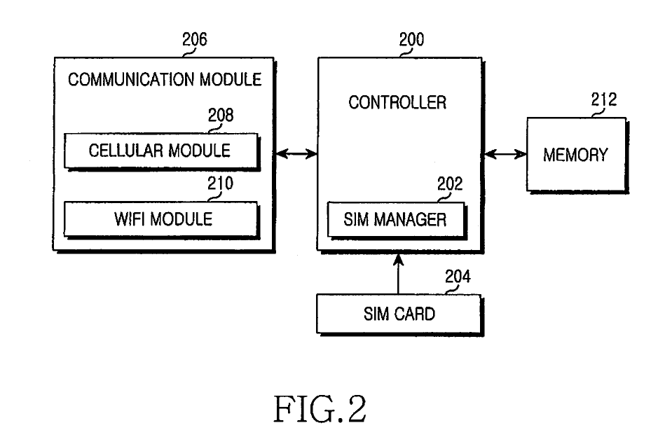

FIG. 2 is a block diagram of a portable terminal according to the present invention. In FIG. 2, the portable terminal includes a controller 200, a SIM card 204, a communication module 206, and a memory 212. The controller 200 includes a SIM manager 202. The communication module 206 includes a cellular module 208 and a WiFi module 210.

The controller 200 provides the overall control to the portable terminal. For example, the controller 200 controls voice calls and data communications. In particular, the controller 200 includes the SIM manager 202 and thus, when an emergency call connection event occurs in a state where the WiFi network is accessible, an emergency call connection function is processed and controlled using IMS registration information recorded in the SIM card 204 or IMS registration information pre-stored in the memory 212 according to the insertion state of the SIM card 204.

The SIM manager 202 checks the insertion state of the SIM card 204. Upon detecting the insertion of the SIM card 204, the SIM manager 202 reads the IMS registration information recorded in the SIM card 204, and outputs the read information to the communication module 206. When a signal, which indicates that the IMS core network registration process has been successfully made, is input from the communication module 206, the SIM manager 202 outputs the IMS registration information to the memory 212. In a case where the SIM card 204 is not inserted in the portable terminal, the SIM manager 202 reads the IMS registration information pre-stored in the memory 212, and delivers the read information to the communication module 206. The IMS registration information may include security information, Proxy-Call Session Control Function (P-CSCF) information, public Uniform Resource Identifier (URI) information, and private URI information.

The communication module 206 includes the cellular module 208 and the WiFi module 210 and, thus, processes signals transmitted/received through the cellular network and the WiFi network. Further, the communication module 206 searches for a network to which the portable terminal can be currently accessed, and delivers information on the found network to the controller 200. Under the control of the controller 200, the communication module 206 performs a function for connecting an emergency call by using the cellular network and the WiFi network. In particular, the communication module 206 registers the portable terminal to the IMS core network by using the IMS registration information input from the controller 200, and thus performs a function for connecting the emergency call using a Voice over Internet Protocol (VoIP) call through the WiFi network.

The memory 212 stores a variety of programs for general operations of the portable terminal, micro code, and data that can be updated. In particular, according to the present invention, the memory 212 receives the IMS registration information from the controller 200 and then stores the information.

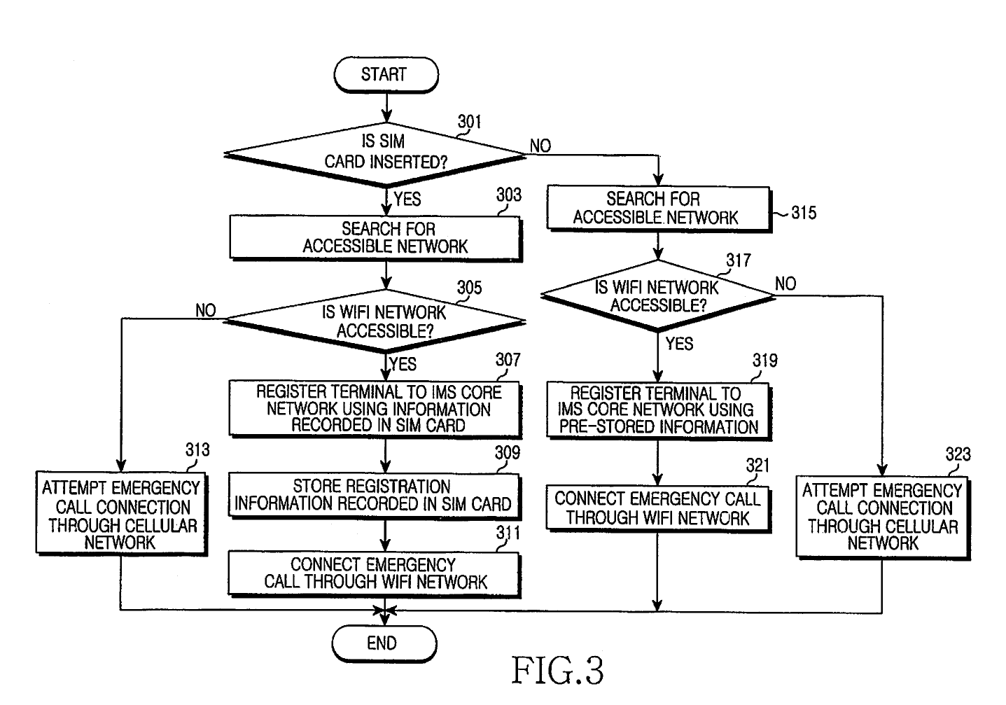

FIG. 3 is a flowchart illustrating a process of connecting an emergency call in a portable terminal according to the present invention.

In FIG. 3, in step 301, insertion of a SIM card in the portable terminal is checked. Upon detection of the insertion of the SIM card, in step 303, a currently accessible network is searched in a state where at least one network is accessible. In step 305, a determination is made as to whether the WiFi network is accessible. In this case, by determining the accessibility of only the WiFi network, in a state where the cellular network and the WiFi network are both accessible, the portable terminal attempts an emergency call connection through the WiFi network first before attempting an emergency call connection through the cellular network.

If the WiFi network is accessible, in step 307, the portable terminal is registered to an IMS core network by using IMS related information (e.g., security information, P-CSCF information, and public and private URIs information) recorded in the SIM card. In step 309, the IMS related information is stored in the memory 212 of FIG. 2. In step 311, the emergency call is connected using a VoIP call through the WiFi network. Then, the process is ended.

If the WiFi network is not accessible, that is, only the cellular network is accessible, in step 313, an emergency call connection is attempted using the cellular network, and, thereafter, the process ends.

If the SIM card is not inserted, in step 315, a currently accessible network is searched for in a state where at least one network is accessible. Then, in step 317, it is determined whether the WiFi network is accessible.

If the WiFi network is not accessible, in step 319, the portable terminal is registered to the IMS core network by using the IMS related information recorded in the memory 212 of FIG. 2. In step 321, an emergency call is then connected using the VoIP call through the WiFi network, and the process then ends.

Otherwise, that is, when only the cellular network is accessible, in step 323, the emergency call connection is attempted using the cellular network, and the process then ends.

According to the present invention, IMS registration information recorded in a SIM card is pre-stored in a memory of a dual mode portable terminal supporting a cellular network and an unlicensed-band network. Thus, a user can place an emergency call even if the SIM card is not inserted in the portable terminal in a state where only the unlicensed-band network is accessible.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the invention has been shown and described with reference to certain preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A method of connecting an emergency call in a portable terminal supporting a cellular network and an unlicensed-band network, the method comprising the steps of:
if an emergency call connection event occurs, searching for an accessible network and checking an insertion state of a Subscriber Identification Module (SIM) card;
if the unlicensed-band network is accessible and the SIM card is not inserted, performing an IP-based Multimedia Subsystem (IMS) registration process by using information pre-stored in a memory; and
connecting the emergency call through the unlicensed-band network.

2. The method of claim 1, further comprising:
if the unlicensed-band network is accessible and the SIM card is inserted, performing the IMS registration process by using information recorded in the SIM card;
storing, in the memory, the information recorded in the SIM card, and updating the information; and
connecting the emergency call through the unlicensed-band network.

3. The method of claim 1, wherein the information pre-stored in the memory is the same as the information which is recorded in the SIM card and is used when the IMS registration process is last performed.

4. The method of claim 1, wherein the information pre-stored in the memory includes at least one item selected from a group consisting of security information, Proxy-Call Session Control Function (P-CSCF) information, and public and private Uniform Resource Identifiers (URIs) information.

5. An apparatus for connecting an emergency call in a portable terminal supporting a cellular network and an unlicensed-band network, the apparatus comprising:
a memory for storing information which is recorded in a Subscriber Identification Module (SIM) card and is used when an IP-based Multimedia Subsystem (IMS) registration process is last performed;
a controller for reading the information stored in the memory and outputting the read information to a communication module when an emergency call event occurs in a state that the unlicensed-band network is accessible; and
the communication module for performing the IMS registration process by using the information stored in the memory and connecting an emergency call through the unlicensed-band network.

6. The apparatus of claim 5, further comprising the SIM card having the information required to perform the IMS registration process, wherein, when the emergency call connection event occurs, the controller detects the insertion of the SIM card, reads the information from the SIM card, and outputs the read information to the communication module and the memory.

7. The apparatus of claim 5, wherein the information stored in the memory includes at least one item selected from a group consisting of security information, Proxy-Call Session Control Function (P-CSCF) information, and public and private Uniform Resource Identifiers (URIs) information.

8. A method of connecting an emergency call in a portable terminal supporting a cellular network and an unlicensed-band network, the method comprising the steps of:
storing, in a memory, information recorded in a Subscriber Identification Module (SIM) card and used to perform an IP-based Multimedia Subsystem (IMS) registration process, and updating the information;
performing the IMS registration process by using the information stored in the memory and updated; and
connecting the emergency call through the unlicensed-band network.

9. The method of claim 8, wherein the step of performing the IMS registration process comprises:
if an emergency call connection event occurs, searching for an accessible network and checking an insertion state of the SIM card; and
if the unlicensed-band network is accessible and the SIM card is not inserted, performing the IMS registration process by using the information stored in the memory and updating the information.

10. The method of claim 9, further comprising:
if the unlicensed-band network is accessible and the SIM card is inserted, performing the IMS registration process by using the information recorded in the SIM card; and
storing, in the memory, the information recorded in the SIM card, and updating the information.

11. The method of claim 8, wherein the information stored in the memory includes at least one item selected from a group consisting of security information, Proxy-Call Session Control Function (P-CSCF) information, and public and private Uniform Resource Identifiers (URIs) information.

12. A portable terminal supporting a cellular network and an unlicensed-band network so as to connect an emergency call, the portable terminal comprising:
a memory for storing information recorded in a Subscriber Identification Module (SIM) card and used when an IP-based Multimedia Subsystem (IMS) registration process is last performed; and
a communication module for connecting an emergency call through the unlicensed-band network after performing the IMS registration process using the information stored in the memory when an emergency call connection event occurs.

13. The portable terminal of claim 12, further comprising:
the SIM card having the information required to perform the IMS registration process; and
a controller for outputting the information recorded in the SIM card to the communication module and the memory by detecting the insertion of the SIM card when the emergency call connection event occurs.

14. The portable terminal of claim 12, wherein the information stored in the memory includes at least one item selected from a group consisting of security information, Proxy-Call Session Control Function (P-CSCF) information, and public and private Uniform Resource Identifiers (URIs) information.

15. An apparatus of connecting an emergency call in a portable terminal supporting a cellular network and an unlicensed-band network, the apparatus comprising:
means for, if an emergency call connection event occurs, searching for an accessible network and checking an insertion state of a Subscriber Identification Module (SIM) card;
means for, if the unlicensed-band network is accessible and the SIM card is not inserted, performing an IP-based Multimedia Subsystem (IMS) registration process by using information pre-stored in a memory; and
means for connecting the emergency call through the unlicensed-band network.
